(19) United States
(12) Patent Application Publication
(10) Pub. No.: US 2023/0186180 A1
(43) Pub. Date: Jun. 15, 2023

(54) INFORMATION PROCESSING SYSTEM, INFORMATION PROCESSING DEVICE, CONTROL METHOD OF INFORMATION PROCESSING DEVICE, AND CONTROL PROGRAM OF INFORMATION PROCESSING DEVICE

(71) Applicant: SoftBank Corp., Tokyo (JP)

(72) Inventors: Ko Chatani, Tokyo (JP); Takashi Isa, Tokyo (JP); Shinya Kojima, Tokyo (JP); Hiroyoshi Hirakawa, Tokyo (JP)

(21) Appl. No.: 18/106,524

(22) Filed: Feb. 7, 2023

Related U.S. Application Data
(63) Continuation of application No. PCT/JP2021/030083, filed on Aug. 17, 2021.

(30) Foreign Application Priority Data
Aug. 19, 2020 (JP) 2020-138717

(51) Int. Cl. G06Q 10/02

(52) U.S. Cl. CPC G06Q 10/02

(57) ABSTRACT

An information processing system includes at least an information processing device and a storage device. The information processing device includes: a point granting unit configured to store an identifier of a company and an identifier of another company in the storage device in correlation with predetermined numbers of points; an availability information acquiring unit configured to acquire availability information on a date and time at which the use object is available to the user of the other company from a user terminal of the company; a use request acquiring unit configured to acquire a use request for the use object from the user of the other company; and a reservation setting unit configured to set a use reservation of the user of the other company for the use object on the basis of the availability information and the use request.

### TECHNICAL FIELD

This disclosure relates to an information processing system, an information processing device, a control method of an information processing device, and a control program of an information processing device.

### BACKGROUND

A system of utilizing a conference room or a drawing room which is not being used has been proposed (for example, Japanese Unexamined Patent Application Publication No. 2002-259850).

### SUMMARY

We provide an information processing system configured to allow a use object which an organization has authority to use to be used by a user of another organization, the information processing system including at least an information processing device and a storage device configured to store object information on the use object. The information processing device includes: a point granting unit configured to store an identifier of the organization and an identifier of the another organization in the storage device in correlation with predetermined numbers of points; an availability information acquiring unit configured to acquire availability information on a date and time at which the use object is available to the user of the another organization; a use request acquiring unit configured to acquire a use request for the use object from the user of the another organization; and a reservation setting unit configured to set a use reservation of the user of the another organization for the use object on the basis of the availability information and the use request. The point granting unit is configured to decrease the number of points correlated with the identifier of the another organization and to increase the number of points correlated with the identifier of the organization on the basis of the setting of the use reservation of the user of the another organization for the use object.

The availability information acquiring unit may be configured to acquire the availability information in a predetermined period before the date and time at which the use object is available to the user of the another organization.

The availability information acquiring unit may be configured to acquire information on a periodic date and time at which the use object is available to the user of the another organization as the availability information.

The availability information acquiring unit may be configured to acquire information on a predetermined threshold value for allowing the use object to be used by the user of the another organization when a period until a date and time at which a use reservation for the use object is not set is equal to or less than the predetermined threshold value and to generate the availability information on the basis of the predetermined threshold value.

The reservation setting unit may be configured to generate authentication information used for authentication from an authentication device provided in the use object and to transmit the authentication information to a terminal of the user of the another organization as the setting of the use reservation, and the point granting unit may be configured to decrease the number of points correlated with the identifier of the another organization and to increase the number of points correlated with the identifier of the company when a notification indicating that the user of the another organization has been authenticated is received from the authentication device.

The use object may have predetermined identification information for identifying the use object, and the point granting unit may be configured to decrease the number of points correlated with the identifier of the another organization and to increase the number of points correlated with the identifier of the organization when the user of the another organization has been authenticated on the basis of the predetermined identification information transmitted from a terminal of the user of the another organization and the use reservation.

The use request acquiring unit may be configured to acquire the use request for the use object from the user of the another organization from a user terminal of the another organization.

The availability information acquiring unit may be configured to acquire availability information on a date and time at which the use object is available to the user of the another organization from a predetermined application that manages a use reservation for the use object from the user of the organization.

The information processing device may further include a first evaluation acquiring unit configured to acquire first evaluation information pertaining to use of the use object by the user of the another organization from a user terminal of the organization, and the point granting unit may be configured to change a degree of decrease of the number of points correlated with the identifier of the another organization on the basis of the first evaluation information.

The information processing device may further include a second evaluation acquiring unit configured to acquire second evaluation information pertaining to the use object of the organization from a user terminal of the another organization, and the point granting unit may be configured to change a degree of increase of the number of points correlated with the identifier of the organization on the basis of the second evaluation information.

The use request acquiring unit may be configured to acquire a use request for the use object from the user of the organization from a user terminal of the company, and the reservation setting unit may be configured to set the use reservation for the use object from the user of the organization and to store reservation information on the use reservation in the storage device.

The information processing system may additionally allow another use object which the another organization has authority to use to be used by the user of the organization.

The information processing system may include a plurality of the organizations and a plurality of the other organizations.

The point granting unit may be configured to store the predetermined numbers of points in the storage device in correlation with a user terminal of the organization and a user terminal of the another organization.

The point granting unit may be configured to increase or decrease the numbers of points correlated with the user terminal of the organization and the user terminal of the another organization on the basis of predetermined point processing operations in the user terminal of the organization and the user terminal of the another organization.

We also provide an information processing device pertaining to an information processing system configured to allow a use object which an organization has authority to use to be used by a user of another organization, the information processing device including: a point granting unit configured to store an identifier of the organization and an identifier of the another organization in a predetermined storage device in correlation with predetermined numbers of points; an availability information acquiring unit configured to acquire availability information on a date and time at which the use object is available to the user of the another organization; a use request acquiring unit configured to acquire a use request for the use object from the user of the another organization; and a reservation setting unit configured to set a use reservation of the user of the another organization for the use object on the basis of the availability information and the use request, wherein the point granting unit is configured to decrease the number of points correlated with the identifier of the another organization and to increase the number of points correlated with the identifier of the organization on the basis of the setting of the use reservation in the reservation setting unit.

We further provide a control method of an information processing device pertaining to an information processing system configured to allow a use object which an organization has authority to use to be used by a user of another organization, the control method being performed by the information processing device, the control method including: a step of storing an identifier of the organization and an identifier of the another organization in a predetermined storage device in correlation with predetermined numbers of points; a step of acquiring availability information on a date and time at which the use object is available to the user of the another organization; a step of acquiring a use request for the use object from the user of the another organization; a step of setting a use reservation of the user of the another organization for the use object on the basis of the availability information and the use request; and a step of decreasing the number of points correlated with the identifier of the another organization and increasing the number of points correlated with the identifier of the organization on the basis of the setting of the use reservation.

We still further provide a control program of an information processing device pertaining to an information processing system configured to allow a use object which a organization has authority to use to be used by a user of another organization, the control program causing the information processing device to perform: a function of storing an identifier of the organization and an identifier of the another organization in a predetermined storage device in correlation with predetermined numbers of points; a function of acquiring availability information on a date and time at which the use object is available to the user of the another organization; a function of acquiring a use request for the use object from the user of the another organization; a function of setting a use reservation of the user of the another organization for the use object on the basis of the availability information and the use request; and a function of decreasing the number of points correlated with the identifier of the another organization and increasing the number of points correlated with the identifier of the organization on the basis of the setting of the use reservation.

### BRIEF DESCRIPTION OF THE DRAWINGS

Features, advantages, and technical and industrial significance of examples of this disclosure will be described below with reference to the accompanying drawings, in which like numerals denote like elements.

FIG. 1 is a diagram schematically illustrating a configuration of an information processing system according to an example.

FIG. 2 is a diagram illustrating an example of functional blocks of a server (an information processing device) and a communication terminal (a user terminal) in the information processing system.

FIGS. 3A and 3B are diagrams illustrating an example of information stored in the information processing system, where FIG. 3A illustrates an example of a user information table and FIG. 3B illustrates a use object table.

FIG. 4 is a diagram illustrating an example of a point information table stored in the information processing system.

FIG. 5 is a diagram illustrating an example of a hardware configuration of an information processing device (a computer).

FIG. 6 is a diagram illustrating an example of an availability information table which is stored in the information processing system.

FIGS. 7A and 7B are diagrams illustrating an example of a reservation information table which is stored in the information processing system.

FIGS. 8A and 8B are diagrams illustrating an example of a display screen of a user terminal in the information processing system.

FIGS. 9A to 9C are diagrams illustrating an example of a display screen of a user terminal in the information processing system.

FIG. 10 is a flowchart illustrating an operation example of an information processing device.

FIGS. 11A and 11B are diagrams illustrating an example of a display screen of a user terminal in the information processing system.

FIGS. 12A to 12C are diagrams illustrating an example of a display screen of a user terminal in the information processing system.

### REFERENCE SIGNS LIST

100 Server (information processing device)
110 Communication control unit
120 Input and output acquiring unit
130 Reservation control unit
131 Availability information acquiring unit
132 Use request acquiring unit
133 Reservation setting unit
140 Point control unit
141 Point granting unit
142 First evaluation acquiring unit
143 Second evaluation acquiring unit
150 Storage unit
200 Communication terminal
210 Communication control unit
220 Display control unit
230 Input and output control unit
231 Availability information input unit
232 Use request input unit
250 Storage unit
251 Point information
300 Storage device
400 Network
500 Information processing system

### DETAILED DESCRIPTION

Hereinafter, an example will be described in detail with reference to the accompanying drawings.

### System Configuration

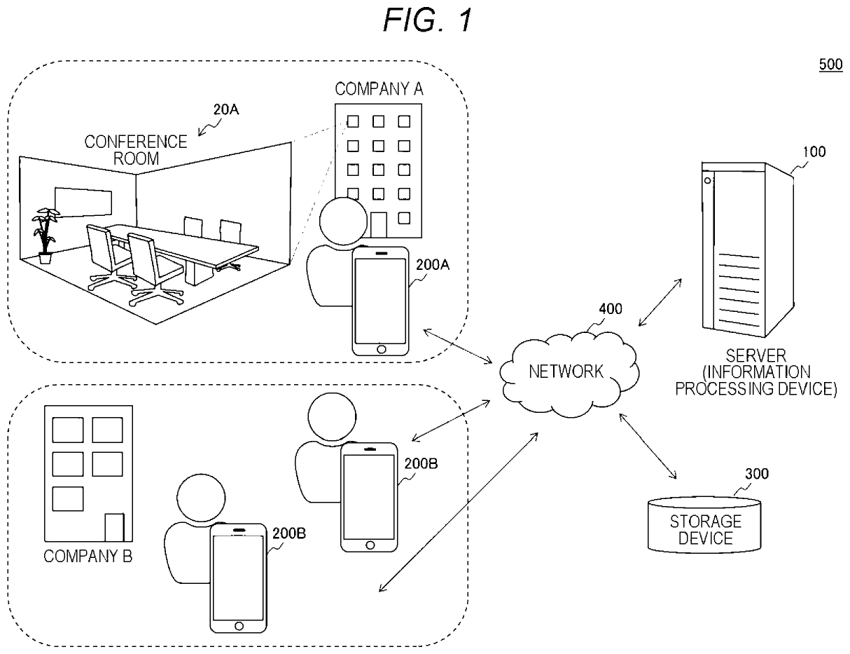

FIG. 1 is a diagram illustrating a configuration example of an information processing system. An information processing system 500 is an inter-company sharing system that can allow a company to use a use object which another company has authority to use. A use object may be a facility, equipment, a service or the like which can be used by a user of the information processing system 500. A use object may be, for example, a space such as a conference room, a drawing room, or an office room provided in a building in which there is an office of a company. A use object is not limited thereto as long as it is a facility or the like which can be used by a user. A building including a use object does not depend on whether it is a company's own building or a rented building. That is, the information processing system 500 according to the example may be a system that allows properties owned by a company to be shared by another company. The information processing system 500 according to the example may be a system that allows properties rented from a company by another company to be shared by still another company. That is, according to the example, it is possible to provide a service that allows users of the information processing system 500 to share idle properties.

In this example, as illustrated in FIG. 1, it is assumed that a conference room 20A which a company A has authority to use is allowed to be used (rented) by a company B as a sharing service of the company A and the company B. In the following description, “A” will be added to reference signs of elements pertaining to the company A and “B” will be added to reference signs of elements pertaining to the company B. For example, a user A and a user B are users pertaining to the company A and the company B, respectively. Users of the information processing system 500 may include a juristic person and a natural person. That is, a company that introduces the information processing system 500 or an employee such as a regular member or a part-time member who works for business of the company may be referred to as a user.

The information processing system 500 may include a server 100, communication terminals 200 (200A, 200B) of users, and a storage device 300. The server 100 may be an information processing device of an administrator side that provides a sharing service. The server 100 can manage a sharing service that is embodied by the information processing system 500. The server 100 may be connected to the communication terminals 200 and the storage device 300 via a network 400. The network 400 may include a wireless network or a wired network. Specifically, the network 400 may be a wireless LAN (WLAN), a wide area network (WAN), an integrated service digital network (ISDN), a wireless LAN, a code division multiple access (CDMA) network, a Long Term Evolution (LTE network), an LTE-Advanced network, a 4th generation communication (4G) network, a 5th generation communication (5G) network, a 6th generation (6G), a mobile communication system subsequent thereto or the like. The network 400 is not limited to these examples, and may be a public switched telephone network (PSTN), a Bluetooth (registered trademark) network, an optical communication line, an asymmetric digital subscriber line (ADSL), a satellite communication network, or the like. The network 400 may be a combination thereof.

In FIG. 1, only one server 100 is illustrated, but this disclosure is not limited thereto. That is, the information processing system 500 may include a plurality of servers. Specifically, the server 100 may be, for example, a distributed server system in which a plurality of distributed servers operate cooperatively by communication via a network, that is, a so-called cloud server. That is, the server 100 is not limited to a physical server, and may be a virtual server.

A communication terminal 200 of a user may be a communication terminal correlated with a user who uses a sharing service which is provided by the information processing system 500. “Correlation” refers to correlation of a communication terminal and a user and, for example, may identify what user inputs information transmitted from a certain communication terminal. Accordingly, for example, when a communication terminal 200 is a terminal shared by a plurality of users, it may mean that a user can be identified through login to a service. For example, an application for using a sharing service may be installed in the communication terminal 200. Alternatively, it is not necessary to install an application in the communication terminal 200, but the communication terminal 200 may access a web page for using a sharing service provided by the server 100 via a web browser or the like. In FIG. 1, a communication terminal of a user who belongs to the company A is referred to as a communication terminal 200A and a communication terminal of a user who belongs to the company B is referred to as a communication terminal 200B, but the communication terminals may be referred to as communication terminals 200 when they are not particularly distinguished. In FIG. 1, smartphones are exemplified as the communication terminals 200, but the communication terminals 200 are not particularly limited as long as they are terminals that can embody functions described below in the following examples. For example, a communication terminal 200 may be a mobile phone (a feature phone), a computer (for example, a tablet, a desktop PC, or a notebook PC), or a small computer device (of which non-restrictive examples include a personal digital assistant (PDA) and a wearable terminal (such as an eyeglass device or a wristwatch device)). In FIG. 1, three communication terminals 200 are illustrated, but the number of communication terminals may be three or more and a plurality of communication terminals (for example, a smartphone and a notebook PC) may be correlated with one user.

The storage device 300 may store (save) various types of information (data) used in the information processing system 500. In FIG. 1, only one storage device 300 is illustrated separate from the server 100, but the storage device may be incorporated into the server 100. That is, the storage device 300 may be a volatile memory or a nonvolatile memory of the server 100. The storage device 30 may include a plurality of storage devices.

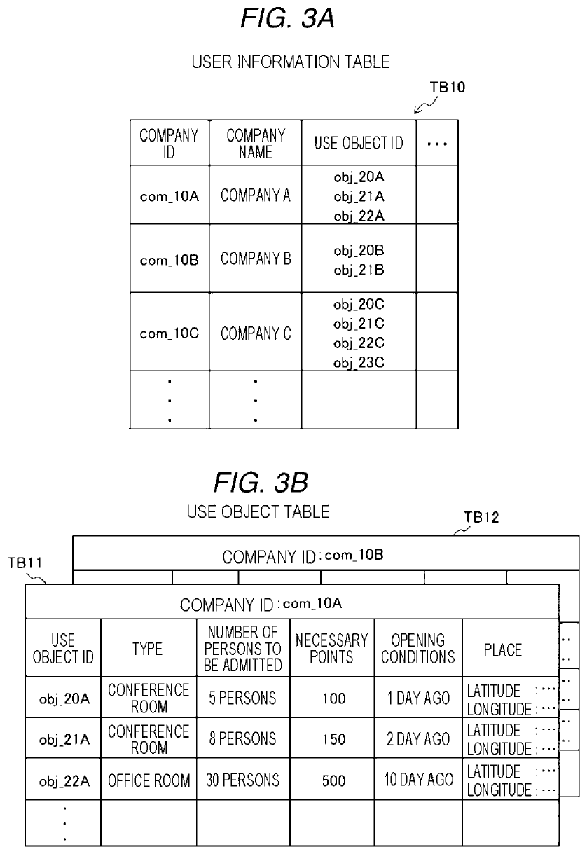

An example of information stored in the storage device 300 is illustrated in FIGS. 3A and 3B. FIG. 3A illustrates an example of a user information table pertaining to users using the information processing system 500, and FIG. 3B illustrates a use object table pertaining to use objects. A table may be a group of various types of information.

The storage device 300 may store identifiers for identifying companies. Each identifier may be constituted by symbols such as characters and numerals. Constituents of an identifier are not particularly limited as long as they can identify a company out of a plurality of companies. The storage device 300 may store names of companies which can use the information processing system 500. A name of a company may be constituted by characters, numerals or the like indicating a full name or an abbreviated name of the company. Constituents of a name of a company are not particularly limited as long as they can identify the company using the information processing system 500. The storage device 300 may store information of use objects which companies have authority to use. Information of a use object may be constituted by symbols such as characters and numerals. Constituents of information of a use object are not particularly limited as long as they can identify a use object out of a plurality of use objects.

The storage device 300 may store identifiers, names of companies, information of use objects owned by the companies and the like in correlation, for example, as a user information table TB10. In FIGS. 3A and 3B, an example in which at least a company ID (an example of an identifier), a company name, and a use object ID (an example of information of a use object) are included in the user information table TB10 is illustrated. “Use object” in the user information table TB10 may refer to a “rent object” which the company A has authority to use and which is an object to be rented to another company. For example, regarding the company A, three use object IDs (“obj_20A,” “obj_21A” and “obj_22A”) are correlated with “com_10A” which is a company ID. That is, for example, the company A has authority to use “obj_20A,” “obj_21A” and “obj_22A” and can rent “obj_20A,” “obj_21A” and “obj_22A” to another company such as the company B or the company C. The storage device 300 may not store a use object ID of a company which uses a sharing service but does not include a use object to be used by another company.

The storage device 300 may store information of employee belonging to a company as user information. User information may include, for example, a user ID for identifying an employee, a company ID of a company to which the corresponding employee belongs, a department, a job, and a mail address. The storage device 300 may store a user ID, a company ID, a department, a job, and a mail address in correlation.

The storage device 300 may store information on use objects of companies (object information) in correlation with use object IDs as use object tables TB11 and TB12. For example, the use object table TB11 may include information on the use object IDs (“obj_20A,” “obj_21A” and “obj_22A”) correlated with the company ID “com_10A.” The use object table TB12 may include information on use object IDs (“obj_20B” and “obj_21B”) correlated with a company ID “com_10B.” As illustrated in FIG. 3B, the storage device 300 may store a type, the number of persons to be accommodated, necessary points, opening conditions, and position information in correlation with the use object ID as the use object table TB11. “Type” may be, for example, a type of a use object such as a conference room, a drawing room, or a free space. Although details will be described later, “necessary points” may be the number of points necessary for using a use object. Although details will be described later, “opening conditions” may be time conditions for setting a use object to be usable by another company. “Place” may be information on an installation place of a use object.

In FIG. 3B, an example in which latitude and longitude are used as the information of “place” is illustrated, but an address may be used. The tables illustrated in FIGS. 3A and 3B are examples of information stored in the storage device 300, and information stored in the storage device 300 may be more or less than the examples. For example, fixture information may be stored in correlation as the use object table TB11. Fixture information is, for example, information of fixtures in a use object which can be used by a user and may be information indicating whether fixtures such as a projector, a whiteboard, a microphone, a speaker, and a spare chair are provided therein. In FIG. 3B, only the use object tables of the companies A and B are illustrated, but tables may be provided for a plurality of companies using a sharing service of the information processing system 500. That is, the storage device 300 may store a use object table for each of a plurality of companies.

### SUMMARY

The summary of a sharing service which is embodied by the information processing system 500 according to an example (a sharing service) will be described below. The information processing system 500 may embody the sharing service using a system employing electronic points. For example, in the sharing service, a predetermined number of points may be granted in advance to a company using the sharing service by a party that provides a platform of the sharing service. That is, a granted number of points may be stored in a predetermined storage unit in correlation with each company as will be described later. Each company may use the points to use a use object which another company has authority to use. That is, for example, when an employee of a company or the like uses a conference room or the like of another company, the sharing service may be embodied through point operations of causing the company borrowing the conference room or the like to pay the points as a reward for renting the conference room or the like to the company lending the conference room or the like. The points may be electronic data. The points may be stored in the storage device 300.

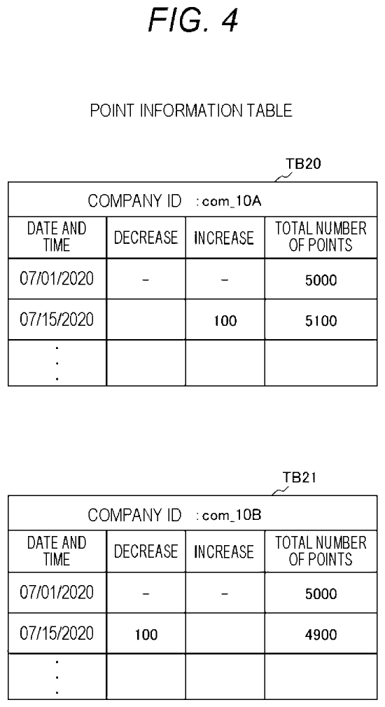

FIG. 4 illustrates an example of a point information table including information on points correlated with companies using the sharing service. In the point information table illustrated in FIG. 4, a decrease in the number of points is described in the field of “decrease,” an increase in the number of points is described in the field of “increase,” and the total number of points is described in the field of “total number of points.” In the point information table illustrated in FIG. 4, a date and time at which the points are correlated, a decrease of the number of points, an increase of the number of points, and the total number of points are described as records. That is, for example, when a user lends a conference room to another user, a date and time at which the conference room is rented may be recorded in the field of “date and time” in the point information tables of the company lending the conference room and the company borrowing the conference room. In the point information table of the company borrowing the conference room, points decreasing with borrowing of the conference room may be recorded in the field of “decrease.” In the point information table of the company lending the conference room, points increasing with lending of the conference room may be recorded in the field of “increase.” In the point information tables of the two companies, the number of points obtained by adding the number of points increasing or decreasing with renting of the conference room to the previous numbers of points may be recorded in the field of “total number of points.” That is, the storage device 300 may store information on a point operation in the sharing service such as a date at which the points are correlated, the total number of points, an increase of the number of points based on the sharing service, and a decrease of the number of points based on the sharing service in correlation with each user.

A flow of points in the sharing service will be specifically described below with reference to the examples illustrated in FIGS. 1 and 4. First, in the example illustrated in FIG. 4, 5000 points is correlated with the company A and the company B on 2020 Jul. 1. It is assumed that a user B of the company B has used a conference room 20A of the company A on 2020 Jul. 15. In this example, the number of points necessary for use of the conference room 20A may be subtracted from the total number of points correlated with the company B as described in a table TB21. In the example illustrated in FIG. 4, 100 points is subtracted from the total number of points of the company B due to use of the conference room 20A. As described in a table TB20, points based on lending of the conference room 20A to the company B may be added to the total number of points correlated with the company A on 2020 Jul. 15. In the example illustrated in FIG. 4, 100 points are added to the total number of points of the company A due to use of the conference room 20A by the company B. The point transferring process such as a decrease or an increase in points may be performed, for example, by a point control unit 140 of the server 100.

For example, when a user registers use of the sharing service, points may be correlated with the user. The number of points which are first granted to the user at the time of registration of use (an initial number of points) may be, for example, the same for all companies (for example, an arbitrary number of points such as 5000 points). The initial number of points may be, for example, the number of points which is arbitrarily designated by a user. For example, a user may designate the initial number of points according to the scale of a company (the number of employees, the number of use objects which the company has authority to use, and a profit margin). The information processing system 500 may correlate the number of points designated by a user with the user. Points may be correlated with a user according to charging of the user. By causing a company to pay a charge to a provider of the sharing service, the information processing system 500 may grant the number of points corresponding to the charge to the company having paid the charge. For example, the point control unit 140 of the server 100 may store action logs of users in a storage unit 150 and correlate the numbers of points with the users on the basis of the action logs. For example, the point control unit 140 may correlate the numbers of points with the users on the basis of information on a reservation cancellation frequency of each user, fuel and light expenses for air conditioning, illumination, and the like. Such information may be acquired from various facilities for air conditioning, illumination, and the like provided in a use object and stored in the storage unit 150 along with a date and time of use. For example, the point control unit 140 may correlate the smaller number of points than other users with a user having a larger cancellation frequency than the other users. That is, penalties may be imposed on users according to a use manner of each user based on the action logs. The action logs are not limited to the aforementioned examples as long as they are arbitrary items allowing a use manner of a user to be ascertained.

In this way, with the information processing system according to the example, payment pertaining to inter-company sharing is performed using points of electronic data which can be used in the sharing service. Accordingly, with the information processing system, it is possible to avoid a troublesome procedure such as a payment procedure which is performed by an individual borrowing a conference room or the like. In the example illustrated in FIG. 4, the company A can acquire points by allowing the conference room A to be use by a user of the company B. Accordingly, with the information processing system, a user can enhance opportunities to use the sharing service while effectively utilizing idle properties. That is, with the information processing system, it is possible to flexibly and actively perform inter-company sharing by introducing a point system.

### Hardware Configuration

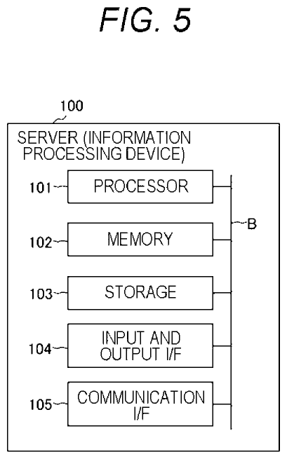

A hardware configuration of the server (information processing device) 100 will be described below with reference to FIG. 5. The hardware configuration of a communication terminal 200 may be the same as that of the server 100. Description of the hardware configuration of a communication terminal 200 will be omitted.

The server 100 may embody functions or methods described in this example by cooperation of a processor 101, a memory 102, a storage 103, an input and output interface (I/F) 104, and a communication I/F 105. For example, the functions or methods may be embodied by causing the processor 101 to execute commands included in a program read into the memory 102.

The processor 101 may perform functions and/or methods embodied by codes or commands included in a program stored in the storage 103. The processor 101 may include, for example, a central processing unit (CPU), a micro processing unit (MPU), a graphics processing unit (GPU), a microprocessor, a processor core, a multiprocessor, an application-specific integrated circuit (ASIC), or a field-programmable gate array (FPGA) and may embody processes disclosed in the examples using a logical circuit (hardware) or a dedicated circuit formed in an integrated circuit (IC) chip, a large-scale integration (LSI) chip or the like. Such a circuit may be embodied by one or more integrated circuits, or a plurality of processes may be embodied by a single integrated circuit. LSI may be referred to as VLSI, super LSI, ultra LSI, or the like depending on a difference in a degree of integration.

The memory 102 may temporarily store a program loaded from the storage 103 and provide a work area to the processor 101. Various types of data which are generated while the processor 101 is executing a program may be temporarily stored in the memory 102. The memory 102 may include, for example, a random access memory (RAM) and a read only memory (ROM).

The storage 103 may store a program. The storage 103 may include, for example, a hard disk drive (HDD), a solid state drive (SSD), and a flash memory.

The communication I/F 105 may be mounted in hardware such as a network adapter or communication software or a combination thereof and perform transmission and reception of various types of data via a network 400. The communication may be performed in a wired manner or a wireless manner. Any communication protocol may be used as long as interactive communication can be performed. The communication I/F 105 may perform communication with a communication terminal 200 via the network 400. The communication I/F 105 may transmit various types of data to the communication terminal 200 or an authentication device which will be described later according to necessity in accordance with an instruction from the processor 101. The communication I/F 105 may receive various types of data transmitted from the communication terminal 200 or the authentication device and deliver the received data to the processor 101.

The input and output I/F 104 may include an input device to which various operations for the server 100 are input and an output device that outputs processing results processed by the server 100. In the input and output I/F 104, the input device and the output device may be unified, or the input device and the output device may be separated. The input device may be embodied by one of all types of devices that can receive an input from a user and transmit information pertaining to the input to the processor 101 or a combination thereof. The input device may include, for example, a touch panel, a touch display, hardware keys such as a keyboard, a pointing device such as a mouse, a camera, or a microphone. The output device may output processing results processed in the processor 101. The output device may include, for example, a touch panel and a speaker.

### Functional Configuration

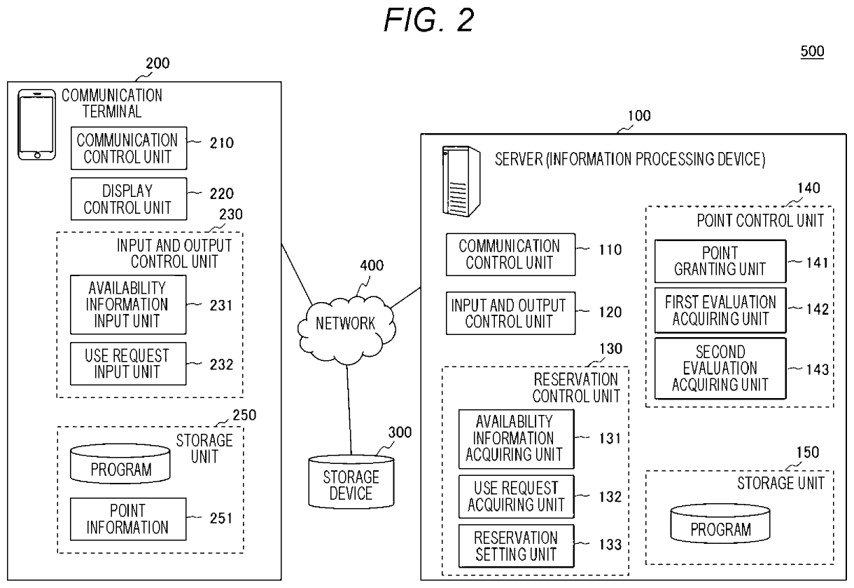

Functional configurations of the server 100 and the communication terminal 200 will be described below with reference to FIG. 2.

### (1) Functional Configuration of Server

The server 100 may include a communication control unit 110, an input and output control unit 120, a reservation control unit 130, a point control unit 140, and a storage unit 150. Functional units illustrated in FIG. 2 are not essential, and nonessential functional units may be omitted in examples which will be described later. Functions or processes of the functional units may be embodied by machine learning or artificial intelligence (AI) in a feasible range.

The communication control unit 110 may control communication with a communication terminal 200 via the communication I/F. The input and output control unit 120 may control delivery of various types of information with an external device via the input and output I/F. For example, the input and output control unit 120 may transmit information to the functional units from the input device which is not illustrated such as a touch panel, a keyboard, or a microphone in accordance with an input instruction from an administrator of the server 100 or transmit information from the functional units to the output device which is not illustrated such as a touch panel, a monitor, and a speaker.

The reservation control unit 130 may include an availability information acquiring unit 131, a use request acquiring unit 132, and a reservation setting unit 133. The availability information acquiring unit 131 may acquire availability information. Availability information may include, for example, information indicating that a use object which a user has authority to use is available to another user in a predetermined period. Specifically, availability information may include, for example, information indicating that a use object such as a conference room 20A is available to another user including a user B in a period in which a user A is not using the use object.

The availability information may be transmitted from a communication terminal 200A of the user A to the server 100. For example, the user A can transmit information indicating that the conference room 20A is available in a period in which the company A does not use the conference room 20A as availability information from the communication terminal 200A to the server 100 such that another company including the company B can use the conference room 20A. That is, the availability information acquiring unit 131 may acquire availability information from a user terminal. The availability information acquired by the availability information acquiring unit 131 may be stored in the storage device 300. The server 100 may automatically receive availability information from a communication terminal of a user. That is, a communication terminal of a user may push availability to the server 100. The server 100 may receive availability information in response to a user's operating a terminal. That is, a communication terminal of a user may transmit availability information to the server 100 at an arbitrary timing in response to the user's operation.

When a use object which a company has authority to use is available to another company, this may be referred to as “a use object is opened.” “Opening” may mean that a use reservation of another company for a use object can be received. “Opening” may mean that information indicating that a use object is available is provided. That is, when a use object is opened, for example, information indicating that a reservation for a use object is set does not need to be provided. Specifically, for example, when an available time period is a period from 10:00 to 11:00, information on a reservation status in the other time period may not be provided. With this configuration, for example, since a user's trend in the other time period can be easily hidden, it is possible to improve convenience in view of security.

In the above-mentioned example, the availability information acquiring unit 131 acquires availability information from a user terminal, but a means for acquiring availability is not limited thereto. For example, the availability information acquiring unit 131 may acquire availability information on the basis of a status of a use reservation recorded in the server 100. For example, the availability information acquiring unit 131 may detect a period in which a use object which a user has authority to use is available to another user on the basis of information on the reservation for the use object and acquire information indicating that the use object is available in the period as availability information. For example, when a use reservation of a next day for a use object of a user A has not been made until a day before, the reservation control unit 130 may acquire information indicating that the use object is available to a user B on the next day as availability information. For example, the reservation control unit 130 may acquire information on a date and time at which a user A has not made a use reservation of the user A for a use object as availability information. For example, when a date and time at which a user A does not use a use object of the user A has been designated, the reservation control unit 130 may acquire information indicating that the use object of the user A is available to a user B at the corresponding date and time as availability information. For example, the server 100 may set whether availability information is to be provided to another user when a use object is available through a user's designation.

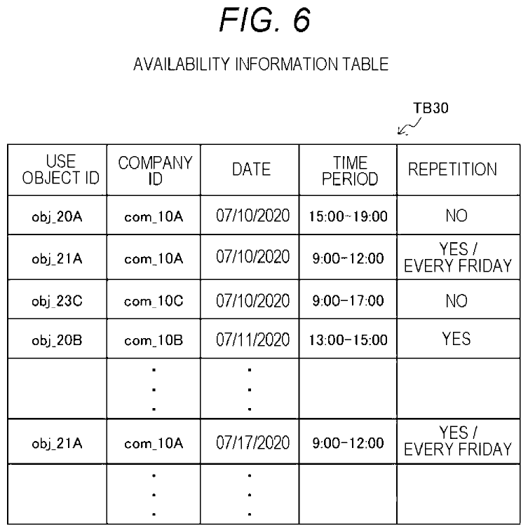

An example of an availability information table stored in the storage device 300 will be described below with reference to FIG. 6. The storage device 300 may store information on a company ID, an available date, a time period, and whether it is repeated in correlation with a use object ID in the availability information table TB30. The availability information acquiring unit 131 may acquire availability information of a conference room 20A from a communication terminal 200A in a predetermined period before a date and time at which the conference room 20A is available to another company. The predetermined period can be freely set by a company and, for example, the user A may transmit information indicating that the conference room A is opened from the communication terminal 200A of the user in one date or one week before the date and time at which the conference room 20A is opened.

The availability information acquiring unit 131 may acquire information on a periodic date and time at which a use object is available to a user of another company as availability information. In the example illustrated in FIG. 6, a use object ID “obj_21A” is opened to another company in a time period of 9:00 to 12:00 every Friday, and information indicating that is stored in the availability information table TB30. The availability information may be generated in response to a user's input as described above or may be automatically generated on the basis of a time period in which a use reservation for the conference room A is not set. That is, when a period until a date at which a use reservation for the use object is not set is equal to or less than a predetermined threshold value, the availability information acquiring unit 131 may acquire information on the predetermined threshold value for allowing a user of another company to use the use object and generate availability information on the basis of the predetermined threshold value. The predetermined threshold value may be, for example, one day, two days, 10 days, or the like. The predetermined threshold value may be stored as “opening conditions” in the use object table TB11.

The availability information acquiring unit 131 may acquire availability information on the basis of a reservation information table pertaining to set reservations which will be described later, the “opening conditions” in the use object table, and the present date. For example, when a use reservation of 2020 Jul. 10 for the use object ID “obj_21A” of which the opening conditions are “2 days ago” is not set at a time point of 2020 Jul. 8, the availability information acquiring unit 131 may acquire a time period in which a use reservation of 2020 Jul. 10 is not set for the use object ID “obj_21A” as availability information. For example, 2020 Jul. 10 9:00 to 12:00 may be stored as availability information of the use object ID “obj_21A” in the storage device 300. That is, with the information processing system according to the example, it is possible to effectively use a use object with a relatively high likelihood that it will not be used. That is, with the information processing system according to the example, it is possible to increase opportunities for a user to use idle properties of another user.

The functions illustrated in FIG. 2 will be successively described below. The use request acquiring unit 132 may acquire a use request for a use object from a user of another company. The reservation setting unit 133 may set a use reservation of the user of the other company for the use object on the basis of the availability information and the use request. The reservation setting unit 133 may store reservation information on the use reservation in the storage device 300. Setting of the use reservation will be described later.

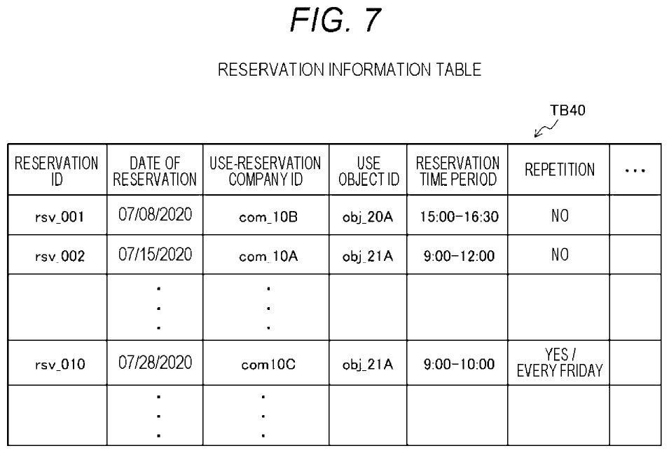

FIGS. 7A and 7B illustrate an example of a reservation information table stored in the storage device 300. The storage device 300 may store a date of a reservation, a company ID of a company having set a use reservation, a use object ID, a reserved time period, repetition which is information indicating setting of a periodic reservation, and the like in correlation with a reservation ID for identifying a corresponding reservation in a reservation information table TB40.

The sharing service may be used when a company reserves use of a facility in the company as well as when a company reserves use of a facility in another company. For example, the use request acquiring unit 132 may acquire a use request of a user A of a company A for a use object (conference room 20A) from a communication terminal 200A of the user A of the company A. The reservation setting unit 133 may set a use reservation of the user A of the company A for the use object and store reservation information on the use reservation in the storage device 300. That is, with the information processing system according to the example, it is possible for the user to reduce labor for preparing different systems as an in-house facility reservation system and an outside facility reservation system. That is, with the information processing system according to the example, it is possible to embody a sharing service with higher convenience.

The functions illustrated in FIG. 2 will be successively described below. The point control unit 140 may include a point granting unit 141, a first evaluation acquiring unit 142, and a second evaluation acquiring unit 143. The point granting unit 141 may store predetermined numbers of points of an identifier of a company and an identifier of another company in the storage device 300 in correlation. The point granting unit 141 may perform increase and decrease of the numbers of points on the basis of setting of a use reservation of a user of the other company for a use object. The point granting unit 141 may decrease the number of points correlated with the identifier of the other company borrowing the use object and increase the number of points correlated with the identifier of the company lending the use object, for example, on the basis of the use reservation. As illustrated in FIG. 4, change of the numbers of points may be stored as a point information table in the storage device 300.

The storage unit 150 may store various programs or various types of data required for the server 100 to operate in the storage 103 or the like.

### (2) Functional Configuration of Communication Terminal

The functional configuration of a communication terminal 200 will be described below with reference to FIG. 2. The communication terminal 200 may include a communication control unit 210, a display control unit 220, an input and output control unit 230, and a storage unit 250. The functional units illustrated in FIG. 2 are not essential, and nonessential functional units may be omitted in examples which will be described later. Functions or processes of the functional units may be embodied by machine learning or artificial intelligence (AI) in a realizable range.

The communication control unit 210 may control communication between the communication terminal 200 and an external device (the server 100) via the network 400 such that transmission and reception of various types information are performed. That is, the communication control unit 210 may transmit availability information or a use request for a use object to the server 100. The display control unit 220 may control display of data on a display screen such as a display or a touch panel. The input and output control unit 230 may receive an input operation from a user via a keyboard, a touch panel, or a microphone. The input and output control unit 230 may transmit information from the functional units to an output device which is not illustrated such as a touch panel, a monitor, and a speaker.

The input and output control unit 230 may include an availability information input unit 231 and a use request input unit 232. The availability information input unit 231 may receive a user's input pertaining to a date and time or conditions at which a use object is available (opened) to another company.

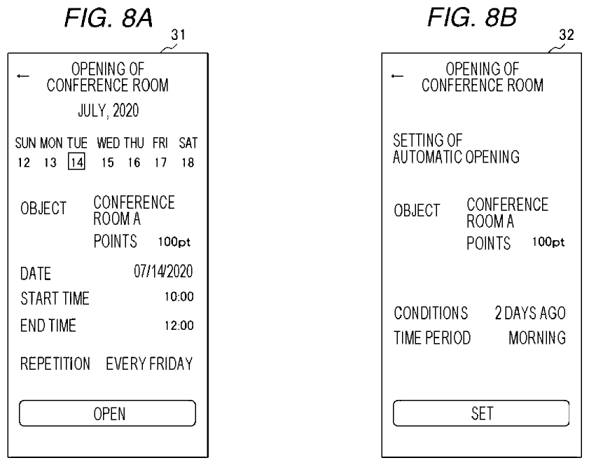

FIGS. 8A and 8B illustrate examples of a setting screen for setting opening of a use object which is displayed on a display screen of the communication terminal 200 by the display control unit 220. FIG. 8A illustrates an example of individual setting which is performed by a user. The user may input a use object opened to another company, a date, a time period, and information indicating repetition using the communication terminal 200 and set opening of the use object. When repetition is set to YES, a periodic opening date and time can be set. FIG. 8B illustrates an example of setting for automatically opening a use object. A user may set opening conditions of the use object using the communication terminal 200. For example, in the example illustrated in FIG. 8B, a use object for which a reservation has not been set after 2 days has passed can be opened at a predetermined time (for example, 0:00 at which a date changes).

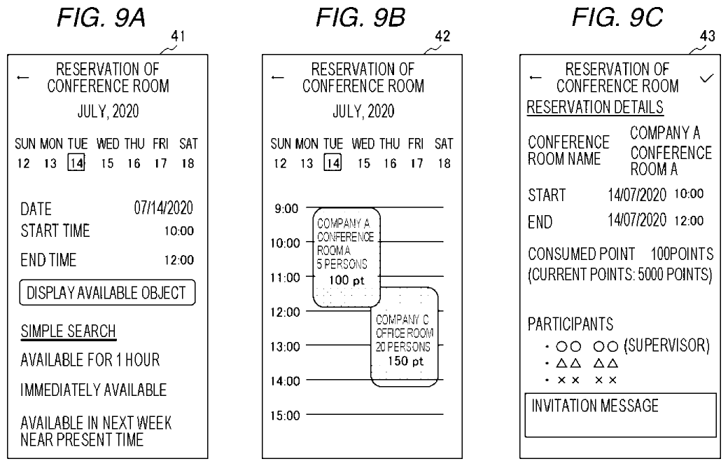

The use request input unit 232 may receive an input of a use request from a user. FIGS. 9A and 9B illustrate an example of an input screen of a use request which is displayed on the display screen of the communication terminal 200 by the display control unit 220. FIG. 9A illustrates an example of a screen 41 for receiving an input of a scheduled date of use and a scheduled time period from a user. The use request input unit 232 may transmit information received via the screen 41 to the server 100. The use request acquiring unit 132 of the server 100 may transmit availability information based on the received information to the communication terminal 200 with reference to an availability information database.

FIG. 9B illustrates an example of a screen 42 on which information of a use object available is displayed on the basis of the availability information received from the server 100. As displayed on the screen 42, information on the number of points required for a use object available may be displayed on the display screen of the communication terminal 200. The use request input unit 232 of the communication terminal 200 may receive a selection operation from a user over the screen 42 and transmit a user request to the server 100. The reservation setting unit 133 of the server 100 may set a reservation for the use object on the basis of the use request transmitted from the communication terminal 200. The reservation setting unit 133 may update the reservation information table TB40 on the basis of the setting of a reservation. The server 100 may transmit information indicating a reservation has been set to the communication terminal 200. FIG. 9C illustrates an example of a reservation completion screen 43 on which details of the reservation are displayed. When information indicating that a reservation has been set is received, the display control unit 220 of the communication terminal 200 may display the reservation completion screen 43 on the display screen. As displayed on the screen 43, the conference room 20A may be used by a plurality of persons. The server 100 may transmit reservation information to the users (participants).

The storage unit 250 may store various programs or various types of data required for the communication terminal 200 to operate. For example, the communication terminal 200 may store an application program for using the sharing service. The storage unit 250 may store the number of points correlated with the communication terminal 200.

### Control Method of Server

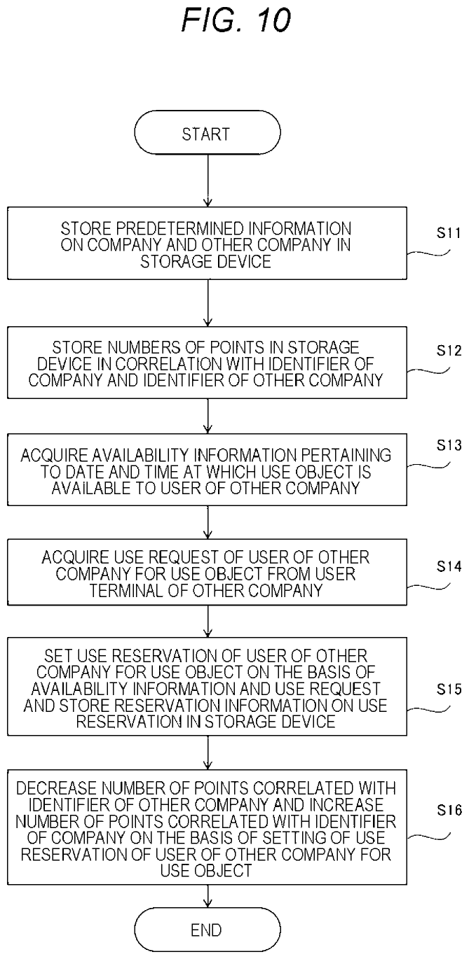

A control method of the server 100 will be described below with reference to a flowchart illustrated in FIG. 10. First, the server 100 may store user information of a company and another company in the storage device 300 (Step S11). Accordingly, the storage device 300 can store a user information table and a use object table. Then, the point granting unit 141 may store predetermined numbers of points in correlation with an identifier of the company and an identifier of the other company in the storage device 300 (Step S12). Accordingly, the storage device 300 can store a point information table. The availability information acquiring unit 131 may acquire availability information on a date and time at which a use object is available to a user of the other company (Step S13). The availability information may be transmitted to the server 100 through the processes in the communication terminal 200 described above with reference to FIGS. 8A and 8B. The use request acquiring unit 132 may acquire a use request of the user of the other company for the use object (Step S14). The use request may be transmitted to the server 100 through the processes in the communication terminal 200 described above with reference to FIGS. 9A to 9C. The reservation setting unit 133 may set a use reservation of the user of the other company for the use object on the basis of the availability information and the use request and store reservation information on the use reservation in the storage device (Step S15). Accordingly, the storage device 300 can store a reservation information table. Thereafter, the point granting unit 141 may decrease the number of points correlated with the identifier of the other company and increase the number of points correlated with the identifier of the company on the basis of setting of the use reservation for the use object from the user of the other company (Step S16). Accordingly, the point information table can be updated and payment associated with sharing can be established among companies.

In this way, with the information processing system according to the example, it is possible to use points which are centrally processed by the server 100 for an inter-company sharing service. Accordingly, the information processing system can establish payment between companies, not between users. That is, with the information processing system, it is possible to embody a sharing service with high usability.

In the aforementioned example, update (decrease and increase) of the number of points is performed at a time point at which a reservation has been set. However, update of the number of points may not necessarily performed at the time of reservation. That is, processes such as decrease and increase of the number of points may be performed on different dates. For example, the number of points may be subtracted from the total number of points correlated with the company B on a date at which the user B has set a use reservation for the use object of the company A, and the number of points may be added to the total number of points correlated with the company A on a date at which the user B has used the use object of the company A according to the reservation. In this way, movement of points may be arbitrarily performed in a range in which the sharing service is realizable. Update of the number of points may be performed at a time point at which use by the other company has been confirmed. The time point at which the use has been confirmed may be, for example, a time point at which use of the use object has been started (checked-in) by the user of the other company. Specifically, the time point may be, for example, a time point at which information (check-in information) indicating that the user of the other company has started use of the use object has been transmitted to the server 100.

Check-in for starting use of a use object will be described below in brief. For example, a user may perform check-in using a check-in device (an authentication device) which is provided in a use object. The reservation setting unit 133 may generate authentication information which is used for authentication with the check-in device (not illustrated) provided in the use object as setting of a use reservation. The reservation setting unit 133 may transmit the authentication information to the communication terminal 200 of a user. The authentication information may be, for example, a QR code (registered trademark) or information which is used in short-range wireless communication, face authentication, or the like. For example, the user may perform check-in by inputting the authentication information to the check-in device. Specifically, for example, a QR code may be transmitted as the authentication information to the communication terminal 200 of the user. The check-in device may be installed, for example, in an entrance of the use object or may include a device that can read the authentication information such as a QR code.

The user may cause a reader to read a QR code displayed on a screen of the communication terminal 200. Accordingly, the authentication information may be transmitted as check-in information from the check-in device to the server 100. The server 100 may determine whether the communication terminal 200 causing the check-in device to acquire the authentication information is owned by a user having reserved the use object. The server 100 may determine that the user has checked in the use object when it is determined that the communication terminal is the user having reserved the use object. The authentication information is not particularly limited as long as it is information used in an existing authentication technique. The authentication information may be transmitted to all persons who use the use object. In this way, when it is notified that authentication has succeeded by a locking/unlocking device, the server 100 may decrease the number of points correlated with the identifier of the other company and increase the number of points correlated with the identifier of the company.

Predetermined identification information for identifying a use object may be installed in the use object. For example, a QR code, a radio frequency identifier (RFID), or a beacon signal transmitter may be installed in an entrance of the use object. The communication terminal 200 of a user may acquire the predetermined identification information such as a QR code, tag information of an RFID, and a beacon signal as check-in information and transmit the check-in information to the server 100. The server 100 may determine whether the communication terminal 200 having transmitted the predetermined identification information is owned by a user having reserved the use object on the basis of (reservation information of) the set use reservation. When it is determined that the communication terminal is owned by the user having reserved the use object, the server 100 may determine that the user has checked in the use object.

The check-in device may be a device that restricts or permits use of the use object. For example, the check-in device may be a device that controls an electronic lock which can lock the use object. For example, when it is determined that the user has checked in the use object, the server 100 may transmit information for unlocking the electronic lock provided in the use object to the check-in device. For example, the check-in device may allow the user to enter a conference room which is the use object by unlocking the electronic lock.

In this way, with the information processing system according to the example, it is possible to update the number of points at a time point at which a user reliably has used a use object. That is, with the information processing system, it is possible to reduce a likelihood of overpayment or delay of payment.

### Weighting of Points

In the aforementioned example, a mode in which the number of points required for each use object is set, the set number of points in a party having provided the use object is increased, and the set number of points in a company having used the use object is decreased has been described above. However, a degree of increase/decrease of the number of points may be changed according to predetermined conditions. For example, the point control unit 140 may further include a first evaluation acquiring unit 142 and a second evaluation acquiring unit 143. The first evaluation acquiring unit 142 may acquire first evaluation information on use of a use object (the conference room 20A) by a user B of the other company B from a communication terminal 200A of a user of the company A. The point granting unit 141 may change a degree of decrease of the number of points correlated with the identifier of the other company B on the basis of the first evaluation information. The second evaluation acquiring unit 143 may acquire second evaluation information on the use object (the conference room 20A) of the company from the communication terminal 200B of the other company B. The point granting unit 141 may change a degree of increase of the number of points correlated with the identifier of the company A on the basis of the second evaluation information.

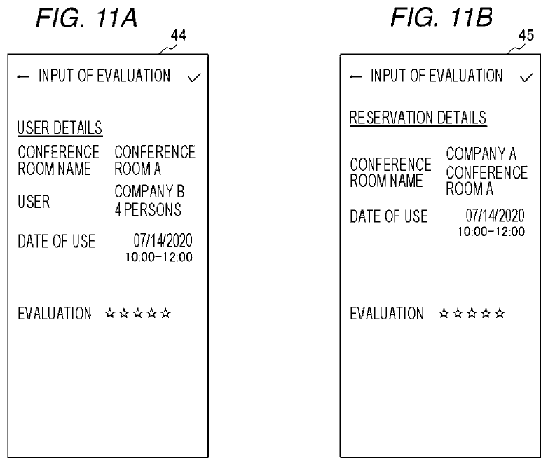

Description with reference to FIGS. 11A and 11B will be successively made. FIG. 11A illustrates an example of an evaluation input screen of the communication terminal 200A for allowing the user A of the company A to input an evaluation (a first evaluation) for the user of the company B having used the conference room 20A of the company A. As displayed on a screen 44 illustrated in FIG. 11A, the user A of the company A may input information for evaluating the user B of the company B regarding a way of use of the conference room 20A provided by the company A. For example, as illustrated in FIG. 11A, the communication terminal 200 may input an evaluation level for evaluating the user B in multiple levels. When the evaluation of the company B is considered to be high on the basis of the first evaluation acquired by the first evaluation acquiring unit 142, the point granting unit 141 of the server 100 may decrease the number of points to be decreased from the company B or add a predetermined number of points as an incentive after the number of points required for use of the conference room 20A has been subtracted. Alternatively, the point granting unit 141 of the server 100 may increase the number of points to be subtracted from the company B when the evaluation of the company B based on the first evaluation is low. Accordingly, with the information processing system, it is possible to curb a rude way of use by a user who uses a use object.

The user B of the company B may be able to evaluate the conference room 20A. FIG. 11B illustrates an example of an evaluation input screen of the communication terminal 200B for allowing the user B of the company B to input an evaluation (a second evaluation) for the conference room 20A. As in a screen 45 illustrated in FIG. 11B, the user B of the company B may input evaluation information for the conference room 20A used by the user B. For example, an evaluation level in multiple levels for evaluation items (for example, cleanliness, types of fixtures, and convenience) of the conference room 20A may be able to be additionally input to the communication terminal 200. The point granting unit 141 of the server 100 may decrease the number of points of the company A when the evaluation of the company A based on the second evaluation acquired by the second evaluation acquiring unit 143 is low. Alternatively, the point granting unit 141 of the server 100 may increase the regular number of points required for use of the conference room 20A and then further add a predetermined number of points as an incentive when the evaluation of the company A based on the second evaluation is high. Accordingly, with the information processing system, it is possible to give a motivation for providing a use object easy to use to a user who provides the use object.

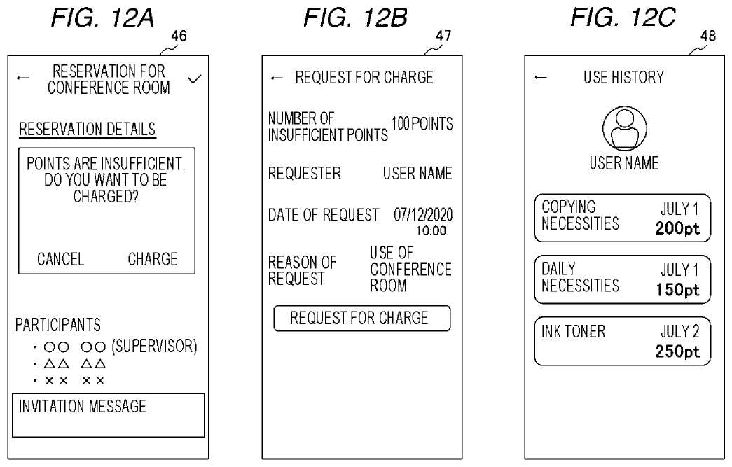

In the aforementioned example, a configuration in which points correlated with companies are used for sharing has been described above. However, points may be correlated with users belonging to companies and the users may personally consume or charge the points. For example, a user may use the points to purchase daily necessaries. In this example, the server 100 may decrease the number of points individually correlated with the user. When consumption of points by the user is associated with business, the server 100 may decrease the number of points correlated with the company instead of the user. This may be embodied, for example, by displaying a screen for selecting consumption associated with business or personal consumption on the display screen of the communication terminal 200 and receiving a selection from a user at the time of performing an operation of consuming points. The number of points may be increased (charged) through payment of money or may be used for an application other than sharing. FIGS. 12A to 12C illustrate an example of the display screen of the communication terminal 200 that performs a process pertaining to points. FIGS. 12A and 12B illustrate an example of a screen 46 for allowing a user to select whether to charge points, for example, when the number of points required for reserving a use object and a charge request screen 47. FIG. 12C illustrates an example of a display screen 48 of a point consumption history of a user.

In this way, with the information processing system, it is possible to use points for purchasing commodities in addition to sharing. Accordingly, with the information processing system, it is possible to give a motivation for increasing the number of points to a user and to more activate the sharing service.

While this disclosure has been described above with reference to the drawings or the examples, those skilled in the art can modify or alter the disclosure in various forms on the basis of the disclosure. Accordingly, it should be understood that modifications or alterations are included in the scope of this disclosure. For example, the elements, the functions included in the steps and the like can be rearranged unless logical conflictions arise, and a plurality of elements, steps or the like may be combined into one element, step, or the like or one element or step may be divided. The elements described in the examples may be appropriately combined. For example, the elements described to be provided in the server 100 may be divisionally embodied by a plurality of servers.

For example, a conference room in an office has been exemplified above as a use object. However, the use object may be a recreation room, a napping room, a shower room, a beauty salon, a nail salon, or a massage or chiropractic corner which is installed in an office. The use object is not limited to an office, but may be a room of a hotel. With today's social expansion allowing workers to freely select workplaces, it is possible that a room of a hotel be provided as a working space. In this example, the information processing system can also be applied.

An example in which availability information of a use object is transmitted from the communication terminal 200 of a user has been described above. However, availability information may be acquired from predetermined management applications that manage use reservations for use objects and that are used by companies. The management application may be, for example, an existing scheduling application or an existing mail application, and the server 100 may acquire availability information from an application program interface (API) which is provided by such an application. Accordingly, a user of a company can receive advantages of a sharing service while continuously using an application which has already been used thereby.

Another company B can also open a use object thereof to the company A. Since sharing is smoothly carried out through introduction of points, it is possible to actively perform inter-company sharing.

An example in which points are weighted on the basis of evaluation information has been described above. However, weighting of points may be performed on the basis of a rate of use of the sharing service. That is, more points may be correlated with a company with a larger frequency of lending facilities thereof to other companies using the sharing service, or a company with a larger borrowing frequency may be weighted such that the number of points required for borrowing facilities of other companies is decreased.

A program according to the example may be provided to an information processing device in a state in which the program is stored in a computer-readable storage medium. The storage medium is a “non-transitory tangible medium” that can store a program. The program includes, for example, a software program or an information processing device program. When the functional units of an information processing device 100 are embodied in software, the information processing device 100 serves as the communication control unit 110, the input and output control unit 120, the reservation control unit 130, and the point control unit 140 by causing a processor to execute a program loaded into a memory. When the functional units of the communication terminal 200 are embodied in software, the communication terminal 200 serves as the communication control unit 210, the display control unit 220, and the input and output control unit 230 by causing a processor to execute a program loaded into a memory.

An applicable storage medium may be based on one or more semiconductor, or may include another arbitrary applicable storage medium such as another integrated circuit (IC) (for example, a field-programmable gate array (FPGA) or an application specific IC (ASIC)), a hard disk drive (HDD), a hybrid hard drive (HHD), an optical disc, an optical disc drive (ODD), a magneto-optical disc, a magneto-optical drive, a floppy diskette, a floppy disk drive (FDD), a magnetic tape, a solid state drive (SSD), or a RAM drive, a secure digital card or drive or an appropriate combination of two or more thereof. An applicable storage medium may be volatile, nonvolatile, or a combination of volatile and nonvolatile.

The program may be provided to the server 100 via an arbitrary transmission medium (such as a communication network or broadcast waves) capable of transmitting the program.

The example may be embodied in the form of a data signal embedded in carrier waves in which a program is embodied by electronic transmission.

The program may be mounted, for example, using a script language such as JavaScript (registered trademark) or Python, a C language, a Go language, Swift Koltin, or Java (registered trademark).

This application is a continuation application of International Application No. PCT/JP2021/030083, filed on Aug. 17, 2021, which claims priority of Japanese Patent Application No. 2020-138717, filed on Aug. 19, 2020, the contents of which are hereby incorporated by reference in its entirety.

What is claimed is:

1. An information processing system configured to allow a use object which an organization has authority to use to be used by a user of another organization, the information processing system comprising at least an information processing device and a storage device configured to store object information on the use object,
wherein the information processing device includes:
a point granting unit configured to store an identifier of the organization and an identifier of the another organization in the storage device in correlation with predetermined numbers of points;
an availability information acquiring unit configured to acquire availability information on a date and time at which the use object is available to the user of the another organization;
a use request acquiring unit configured to acquire a use request for the use object from the user of the another organization; and
a reservation setting unit configured to set a use reservation of the user of the another organization for the use object on the basis of the availability information and the use request, and
wherein the point granting unit is configured to decrease the number of points correlated with the identifier of the another organization and to increase the number of points correlated with the identifier of the organization on the basis of the setting of the use reservation of the user of the another organization for the use object.

2. The information processing system according to claim 1, wherein the availability information acquiring unit is configured to acquire the availability information in a predetermined period before the date and time at which the use object is available to the user of the another organization.

3. The information processing system according to claim 1, wherein the availability information acquiring unit is configured to acquire information on a periodic date and time at which the use object is available to the user of the another organization as the availability information.

4. The information processing system according to claim 1, wherein the availability information acquiring unit is configured to acquire information on a predetermined threshold value for allowing the use object to be used by the user of the another organization when a period until a date and time at which a use reservation for the use object is not set is equal to or less than the predetermined threshold value and to generate the availability information on the basis of the predetermined threshold value.

5. The information processing system according to claim 1, wherein the reservation setting unit is configured to generate authentication information used for authentication from an authentication device provided in the use object and to transmit the authentication information to a terminal of the user of the other company as the setting of the use reservation, and
the point granting unit is configured to decrease the number of points correlated with the identifier of the another organization and to increase the number of points correlated with the identifier of the organization when a notification indicating that the user of the another organization has been authenticated is received from the authentication device.

6. The information processing system according to claim 1, wherein the use object has predetermined identification information for identifying the use object, and
the point granting unit is configured to decrease the number of points correlated with the identifier of the another organization and to increase the number of points correlated with the identifier of the organization when the user of the another organization has been authenticated on the basis of the predetermined identification information transmitted from a terminal of the user of the another organization and the use reservation.

7. The information processing system according to claim 1, wherein the use request acquiring unit is configured to acquire the use request for the use object from the user of the another organization from a user terminal of the another organization.

8. The information processing system according to claim 1, wherein the availability information acquiring unit is configured to acquire availability information on a date and time at which the use object is available to the user of the another organization from a predetermined application that manages a use reservation for the use object from the user of the organization.

9. The information processing system according to claim 1, wherein the information processing device further includes a first evaluation acquiring unit configured to acquire first evaluation information pertaining to use of the use object by the user of the another organization from a user terminal of the organization, and
the point granting unit is configured to change a degree of decrease of the number of points correlated with the identifier of the another organization on the basis of the first evaluation information.

10. The information processing system according to claim 1, wherein the information processing device further includes a second evaluation acquiring unit configured to acquire second evaluation information pertaining to the use object of the organization from a user terminal of the another organization, and
the point granting unit is configured to change a degree of increase of the number of points correlated with the identifier of the organization on the basis of the second evaluation information.

11. The information processing system according to claim 1, wherein the use request acquiring unit is configured to acquire a use request for the use object from the user of the organization from a user terminal of the organization, and
the reservation setting unit is configured to set the use reservation for the use object from the user of the organization and to store reservation information on the use reservation in the storage device.

12. The information processing system according to claim 1, wherein the information processing system additionally allows another use object which the another organization has authority to use to be used by the user of the organization.

13. The information processing system according to claim 1, wherein the information processing system includes a plurality of companies and a plurality of another companies.

14. The information processing system according to claim 1, wherein the point granting unit is configured to store the predetermined numbers of points in the storage device in correlation with a user terminal of the organization and a user terminal of the another organization.

15. The information processing system according to claim 14, wherein the point granting unit is configured to increase or decrease the numbers of points correlated with the user terminal of the organization and the user terminal of the another organization on the basis of predetermined point processing operations in the user terminal of the organization and the user terminal of the another organization.

16. A control method of an information processing device pertaining to an information processing system configured to allow a use object which an organization has authority to use to be used by a user of another organization, the control method being performed by the information processing device, the control method comprising:
a step of storing an identifier of the organization and an identifier of the another organization in a predetermined storage device in correlation with predetermined numbers of points;
a step of acquiring availability information on a date and time at which the use object is available to the user of the another organization;
a step of acquiring a use request for the use object from the user of the another organization;
a step of setting a use reservation of the user of the another organization for the use object on the basis of the availability information and the use request; and
a step of decreasing the number of points correlated with the identifier of the another organization and increasing the number of points correlated with the identifier of the organization on the basis of the setting of the use reservation.

17. A non-transitory computer readable medium storing therein a control program of an information processing device pertaining to an information processing system configured to allow a use object which an organization has authority to use to be used by a user of another organization, the control program causing the information processing device to perform:
a function of storing an identifier of the organization and an identifier of the another organization in a predetermined storage device in correlation with predetermined numbers of points;
a function of acquiring availability information on a date and time at which the use object is available to the user of the another organization;
a function of acquiring a use request for the use object from the user of the another organization;
a function of setting a use reservation of the user of the another organization for the use object on the basis of the availability information and the use request; and
a function of decreasing the number of points correlated with the identifier of the another organization and increasing the number of points correlated with the identifier of the organization on the basis of the setting of the use reservation.
